(19) United States
(12) Patent Application Publication
(10) Pub. No.: US 2018/0067914 A1
(43) Pub. Date: Mar. 8, 2018

(54) ENTERPRISE-RELATED CONTEXT-APPROPRIATE USER PROMPTS

(71) Applicant: Alibaba Group Holding Limited, George Town (KY)

(72) Inventors: Hang Chen, Hangzhou (CN); Zhenhao Wu, Hangzhou (CN); Lili Zhang, Hangzhou (CN); Daping Zhang, Hangzhou (CN); Di Zhang, Hangzhou (CN); Lidong Cao, Hangzhou (CN); Di Su, Hangzhou (CN); Yixin Huang, Hangzhou (CN); Jianjun Zhao, Hangzhou (CN)

(73) Assignee: Alibaba Group Holding Limited, George Town (KY)

(21) Appl. No.: 15/697,263

(22) Filed: Sep. 6, 2017

(30) Foreign Application Priority Data
Sep. 8, 2016 (CN) 201610810906.9

(51) Int. Cl. G06F 17/24; G06Q 10/06; G06Q 10/10; G06F 3/0484

(52) U.S. Cl. CPC G06F 17/243; G06Q 10/06315; G06F 3/0482; G06Q 10/063116; G06F 3/0484; G06Q 10/107

(57) ABSTRACT

Embodiments described herein provide a system for generating context-appropriate user prompts from an application. The system improves significantly over previous systems by providing expedient, context-appropriate, and relevant user prompts corresponding to enterprise-related user functions. During operation, a computing device receives a user input in an application window. The device then analyzes the received user input to determine an enterprise objective of a user and an enterprise function associated with the user objective. The device then generates a user prompt corresponding to the enterprise function, and displays the user prompt in the same application window.

### RELATED APPLICATION

Under 35 U.S.C. §119, this application claims the benefit and right of priority of Chinese Patent Application No. 201610810906.9, filed Sep. 8, 2016, the disclosure of which is incorporated by reference herein. This application is related to U.S. patent application Ser. No. 15/469,248, Attorney Docket Number ALI-A9268US, entitled “METHOD AND SYSTEM FOR TASK PROCESSING” filed Mar. 24, 2017, the disclosure of which is incorporated herein by reference.

### BACKGROUND

### Field

The present disclosure relates to the field of enterprise-related communication functions. More specifically, the present disclosure is related to a method and system for generating context-appropriate user prompts from an enterprise messaging application.

### Related Art

In mobile computing, usability, design, and expedience are paramount to the user experience. A primary goal is to increase efficiency in user operations, and yet collaboration and communication are conventionally separate computing functions, leading to duplication of user effort.

Some systems can provide a certain level of context awareness to increase efficiency and expedite the performance of user functions. For example, based on users' social network or search operations context-aware user prompts offer targeted advertisements, or recommend activities.

Savings of time and labor are particularly important in a commercial environment. Yet, previous systems have not made sufficient use of enterprise-relevant context awareness. Context for enterprise-related functions provides different challenges and demands from consumer context. For example, management and collaboration functions may require that both managers and employees follow certain protocols. Moreover, with conventional enterprise computing solutions, users are often required to use different application interfaces to perform different collaborative functions. Switching between these interfaces can be tedious and error-prone.

### SUMMARY

A system and method are provided for generating context-appropriate user prompts from an application. During operation, the system receives a user text input in the application window. The system then analyzes the received user text input to determine an enterprise objective of a user and an enterprise function associated with the user objective. The system then generates a user prompt corresponding to the enterprise function. The system then displays the user prompt in the application window.

### BRIEF DESCRIPTION OF THE FIGURES

FIG. 1 illustrates an exemplary enterprise messaging application, according to an embodiment.

FIG. 2A illustrates a context-appropriate user prompt in an exemplary enterprise messaging application, according to an embodiment.

FIG. 2B illustrates a context-appropriate enterprise-related form including a user option control, according to an embodiment.

FIG. 2C illustrates pre-populated option field values in a context-appropriate enterprise-related form, according to an embodiment.

FIG. 3 illustrates an exemplary user request prompt for a manager's approval, according to an embodiment.

FIG. 4A illustrates usage of a collaboration control button, according to an embodiment.

FIG. 4B illustrates an exemplary list of pending requests received from a user, according to an embodiment.

FIG. 4C illustrates an exemplary list of pending requests sent to a manager, according to an embodiment.

FIG. 5A presents a flowchart illustrating a method for generating context-appropriate user prompts from an enterprise application, in accordance with an embodiment.

FIG. 5B presents a flowchart illustrating a method for generating context-appropriate user prompts based on a context analysis by a server, according to an embodiment.

FIG. 6 illustrates generation of an exemplary user-targeting alert notification, according to an embodiment.

FIG. 7A illustrates exemplary conversational context displayed on a mobile device client, according to an embodiment.

FIG. 7B illustrates a context-appropriate user confirmation prompt generated by a mobile device, according to an embodiment.

FIG. 7C illustrates pre-populated option control values in a context-appropriate form generated by a client, according to an embodiment.

FIG. 8 presents a flowchart illustrating a method for analyzing context using machine learning, according to an embodiment.

FIG. 9A illustrates an exemplary search resulting in a list of pending reimbursement requests, according to an embodiment.

FIG. 9B illustrates an exemplary search resulting in a list of all pending requests sent to a manager, according to an embodiment.

FIG. 10 illustrates user configuration of a request type, according to an embodiment.

FIG. 11 illustrates exemplary historical user input being used by the system to facilitate task management, according to an embodiment.

FIG. 12 illustrates a context-appropriate user prompt to perform a task management function, according to an embodiment.

FIG. 13 presents a block diagram illustrating an exemplary computer system for generating context-appropriate user prompts, according to an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the disclosed system is not limited to the embodiments shown, but is to be accorded the widest scope consistent with the principles and features disclosed herein.

### Overview

Embodiments of the present invention solve the problem of integrating the communication and collaborative functions in an enterprise environment by generating context-appropriate user prompts within an enterprise messaging application. For example, a user may input a chat message or search term. The system can then apply a language processing heuristic to infer an enterprise-related objective based on the user input. The system improves significantly over previous systems by automatically providing expedient, context-appropriate user prompts which allows the user to access directly enterprise functions. The system can further expedite such functions by pre-populating user option controls, e.g., in a form based on the determined context. The system can be integrated with other information sources such as an address book, to facilitate more complex operations, such as submitting information to a manager. In the following description, user “Xiaohei” is used as an example for an employee user, and user “Xiaobai” is used as an example for a manager user.

### Context-Appropriate User Prompts

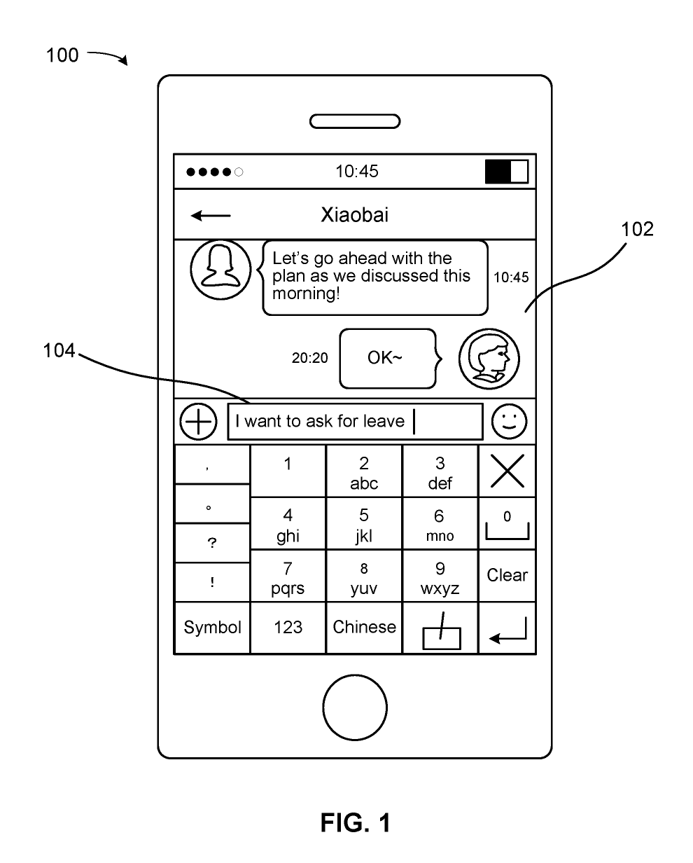

FIG. 1 illustrates an exemplary enterprise messaging application, according to an embodiment. As shown, two enterprise users can exchange messages in a communication session 102 of an Enterprise Instant Messaging (EIM) application. The EIM application allows enterprise users to communicate quickly and effectively about work-related matters, as described further in U.S. patent application Ser. No. 15/469,248, Attorney Docket Number ALI-A9268US, entitled “METHOD AND SYSTEM FOR TASK PROCESSING” filed Mar. 24, 2017, which is incorporated herein by reference. One such EIM application is “DingTalk.”

As shown in FIG. 1, two co-workers can use the EIM platform to discuss upcoming tasks, deadlines, time off, etc. These discussions may relate to work functions to be performed, involving one or both of the participants in the conversation. In the example of FIG. 1, user Xiaohei mentions in a chat message 104 to his manager, Xiaobai, that he intends to take a vacation. In a further example, Xiaohei might tell Xiaobai that a first assigned task has been completed early, but he anticipates challenges completing a second milestone.

These exemplary discussions relate, respectively, to the company's management and control information systems for vacation requests and for task management. These systems could be integrated with the EIM application package, or be standalone applications. Moreover, the discussions contain contextual information that is potentially more up-to-date than the statuses reflected in the vacation or task management systems. Note that the disclosed embodiments are not limited to analyzing discussions via EIM, and can also analyze contextual information obtained from other applications such as Internet or intranet searches, local storage or file system searches, a calendar or other workflow application, an address book or social network, etc.

The disclosed embodiments can use the contextual information obtained from the EIM application to analyze one or more context cues, and determine from them a work-related user function that is relevant to the discussion. In these examples, the user function could be vacation or task management. The system can apply machine learning or language processing to analyze the context. Based on the relevance and the context, the system can further determine that one or more participants in the conversation might want to perform this determined work function soon, and therefore assist them in doing so.

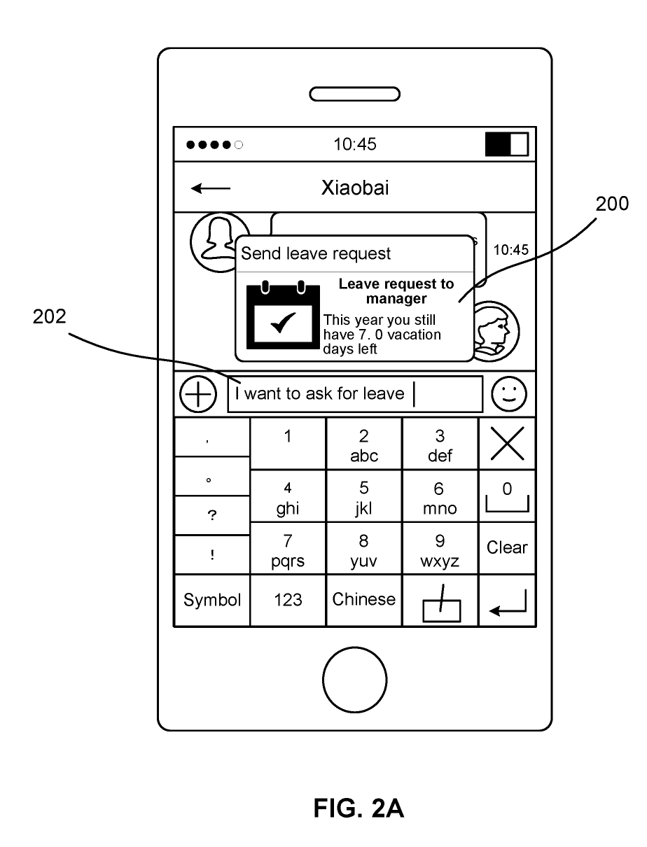

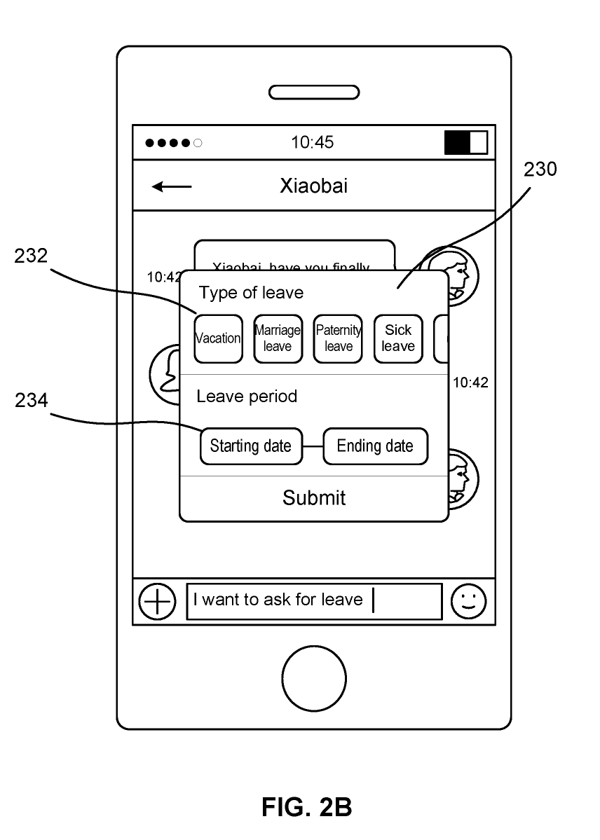

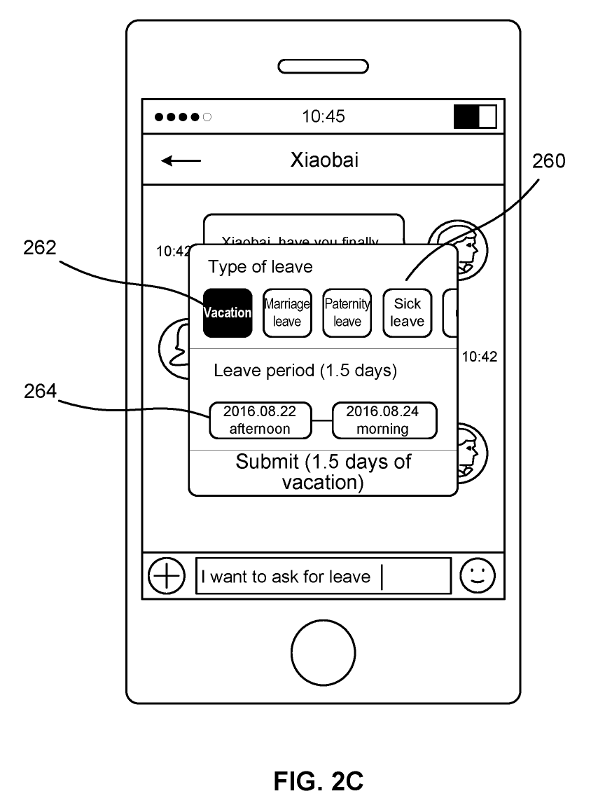

The system can use the conversational context to generate a user prompt to configure this enterprise-related user function. FIG. 2A illustrates a context-appropriate user prompt in an exemplary enterprise messaging application, according to an embodiment. In conjunction with the example in FIG. 1, the system can show Xiaohei a time-off application popup 200, enabling Xiaohei to configure his vacation request expediently. In this example, even before Xiaohei has finished typing message 202, the system can recognize the relevant context and can show a context-appropriate prompt or popup window in response.

In some embodiments, the popup displayed by the system may simply be a confirmation prompt, or a prompt for further action, e.g. “Would you like to request time off?” or “Would you like to open the task management app?” In some embodiments, the system can instead directly open a prompt or window associated with the user function or application, or can gather information on behalf of the user function or application. The system can then open the application related to the user function after the user affirms (e.g., by tapping “yes”) in the initial popup. The system can also incorporate relevant contextual information into the prompt.

FIG. 2B illustrates a context-appropriate enterprise-related form including a user option control, according to an embodiment. In this example, the system displays a form 230 with user controls 232 and 234, either immediately upon determining the relevant context, or after the user first affirms a prompt, like the one shown in FIG. 2A. The user controls can give the user a choice, or gather information for carrying out the user function.

For example, form 230 can include fields that allow the form permits the user to select the type of time off 232, such as vacation, sick or personal days off, unpaid leave, jury duty, etc. The form can also contain a field 234 for the user to specify the start and end dates of the time-off request. Additional fields can be used to allow the user to specify other parameters, such as multiple time intervals, start and end times or partial days off, etc.

In some embodiments, the system can pre-populate the option fields based on the determined context. The system can apply machine learning or language processing to context from the EIM chat, search terms, calendar, or address book, etc., to determine likely values for these fields. FIG. 2C illustrates pre-populated option field values in a context-appropriate enterprise-related form, according to an embodiment. In this example, a form 260 is pre-populated with values “vacation time” 262 for the type of leave and the dates 264 for the leave period. These values can be extracted by the system automatically from the context of Xiaohei's conversation with his manager. For instance, if Xiaohei mentions that he would like to request leave “from this afternoon to Wednesday morning,” the system can extract the corresponding dates 264 from this language. In some embodiments, the user can manually change these pre-populated values, while the pre-populated values represent likeliest choices based on the conversation or context.

Once the user confirms the selections in the form, the system can update the data in the company's information system and/or perform the enterprise-related user function. In some embodiments, the system sends the selection information to a separate application, which performs the user function.

### Interactive Functions

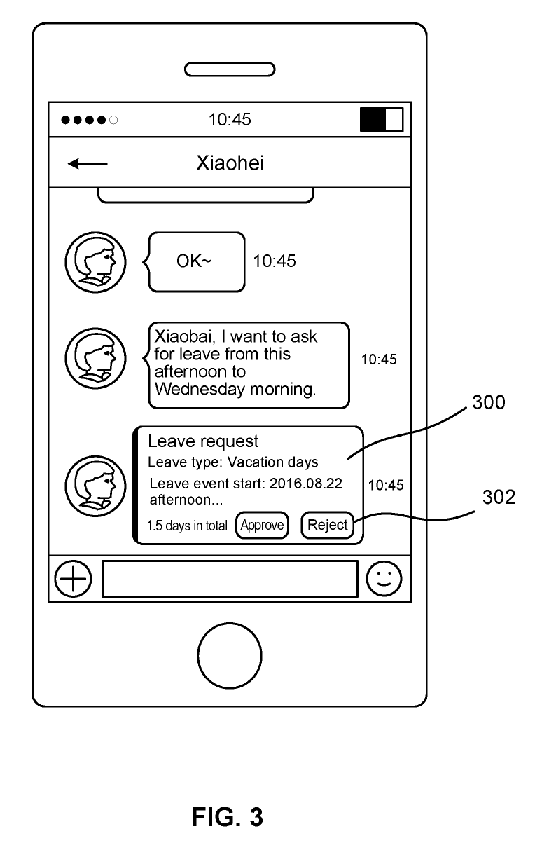

FIG. 3 illustrates an exemplary user request prompt for a manager's approval, according to an embodiment. In this example, Xiaohei's manager Xiaobai can use an EIM session window on her mobile device, which can display a time-off request prompt 300 summarizing Xiaohei's request. The system can display prompt 300 within the EIM session window, enabling Xiaobai to select the “approve” or “reject” buttons 302 directly in the EIM session window. This configuration can simplify Xiaobai's operation, and streamline the collaborative workflow with Xiaohei and other users.

### Pending Request List

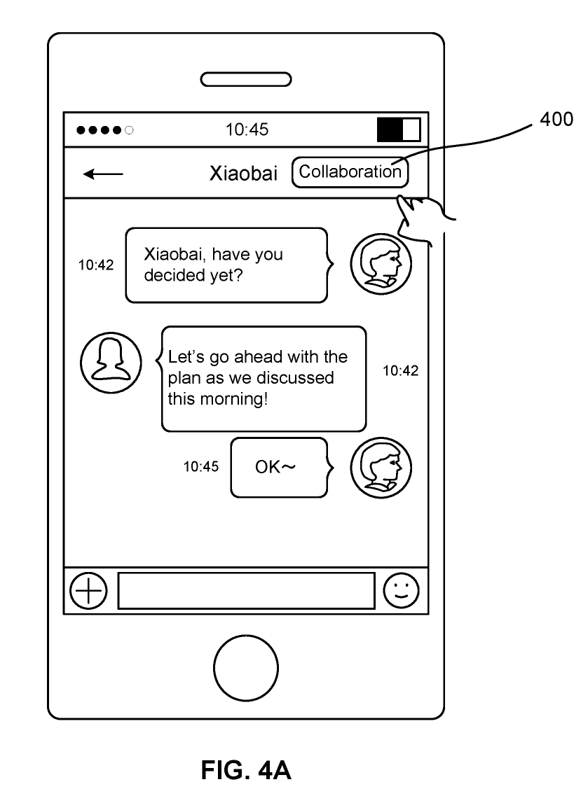

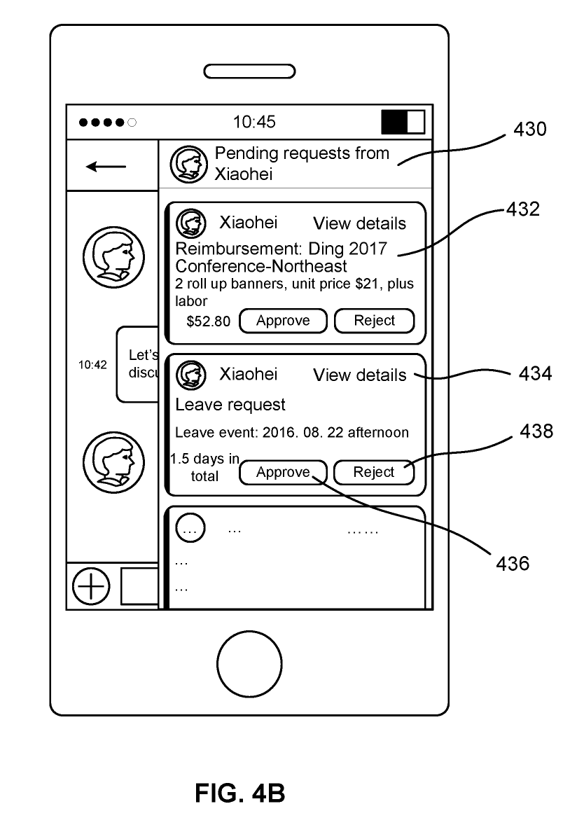

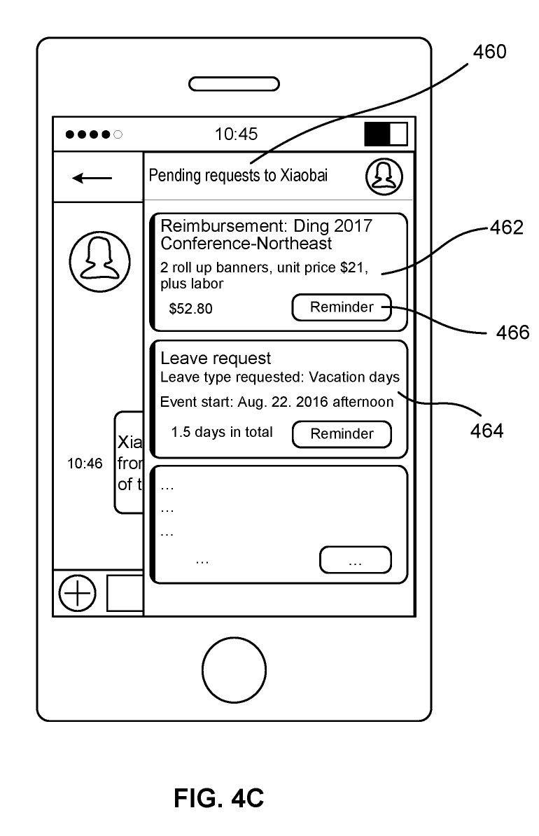

The system can also show searchable lists of pending requests related to collaborative functions. FIG. 4A illustrates usage of a collaboration control button, according to an embodiment. As shown, the system may display a collaboration control 400 (e.g., a button or pull-down icon) in a corner (e.g., the upper-right corner) of the user interface. When the user selects this control, the system can show a pop-up window listing all pending requests, e.g. vacation requests made through the time-off system. Similarly, the system may also display a “collaboration” button in the EIM session window on Xiaobai's device. The resulting list can include all pending requests sent by a user, or received by a manager.

FIG. 4B illustrates an exemplary list of pending requests received from a user, according to an embodiment. In this example, a pending request list 430 includes reimbursement request 432, leave request 434, and other requests, which may or may not require approval by Xiaobai. As shown in FIG. 4B, each request may be displayed with details such as reimbursement amounts, requested vacation dates, task statuses, etc. In some embodiments, the system may instead show the pending request list in a compact view (i.e., without the details of each request fully visible). The system can provide full details of the selected request in response to the user selecting a control such as “view details.” The system can present Xiaobai with further option controls, such as “approve” button 436 and “reject” button 438. In some embodiments, if the “collaboration” button is triggered in an EIM application window, the system can show all requests involving both the local user and the user's conversational partner. Thus, in the example of FIG. 4B, when Xiaobai selects the “collaboration” button, the system shows all requests from Xiaohei to Xiaobai. Optionally, the system may instead show all requests involving the local user.

In some embodiments, request list 430 can be searchable or sortable based on any detail included in the list. For example, details including request type, requester name, manager name, reimbursement amount, task status, timestamp of request, request priority, etc., can be used to search or sort the list. In some embodiments, the search or sort may include compound conditions based on multiple conditions.

FIG. 4C illustrates an exemplary list of pending requests sent to a manager, according to an embodiment. In this example, the EIM interface on Xiaohei's device shows a list 460 including pending reimbursement request 462 and time off 464 requests from Xiaohei to Xiaobai. Each request item may further include a control such as a “ping,” “DING message,” or “reminder” button 466, which allows the user to remind a manager about the pending request. Note that a “DING message” is a “forced reminder,” i.e., a user-targeting alert notification, as described further in U.S. patent application Ser. No. 15/040,659, Attorney Docket Number ALI-A4683US, entitled “NOVEL COMMUNICATION AND MESSAGING SYSTEM” filed Feb. 10, 2016, hereby incorporated by reference in the present application.

### Generating User Prompts

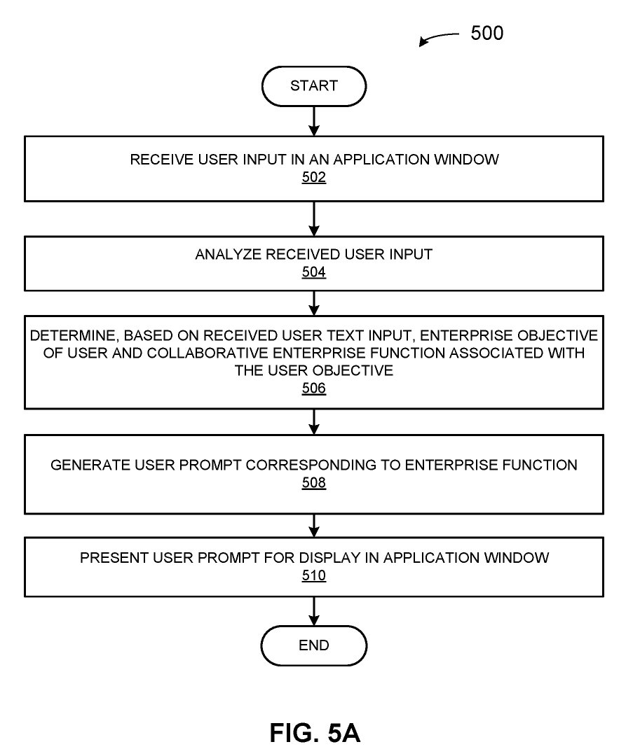

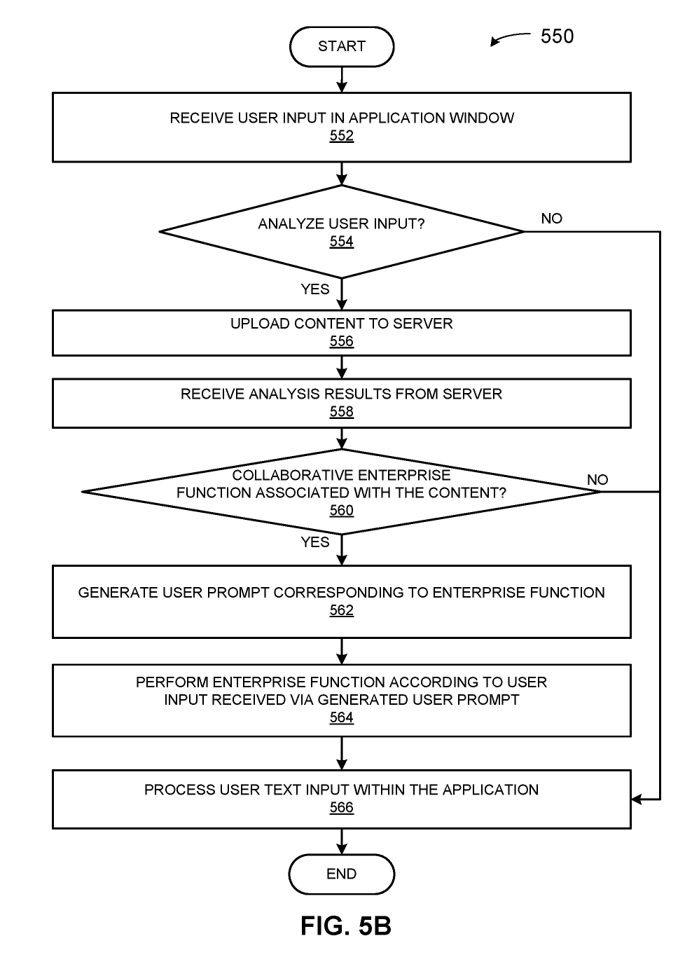

This section describes details of the system's operation. FIG. 5A presents a flowchart illustrating a method for generating context-appropriate user prompts from an enterprise application, in accordance with an embodiment. During operation, the system receives a user input in an application window (operation 502). The application window may include an EIM session window, as shown in FIG. 1. Note that any application window that collects user input content can be used by the system, such as a search page or a workflow application, and is not limited by the present disclosure.

The user input is not limited to text, and can include any content the user inputs in the application. For example, a user Xiaohei can use an EIM text input box or a voice input mode to enter the input content in the system. The user input can also include content input by an EIM conversation partner of the local user, for instance a chat message received by Xiaohei from Xiaobai.

In one embodiment, the system can analyze user input in real time. The system can display a user prompt even before the user completes typing a message. The system can also analyze historical user input, e.g. historical messages loaded when an EIM session starts. For example, the system can recognize that a previous EIM message from Xiaobai such as, “Keep me informed of the project progress” corresponds to an ongoing collaborative task. Thus, the system can show a user prompt relevant to task management when the EIM session loads. Since the user input is a historical message, Xiaohei can access the task management user prompt simply by opening the EIM session window, even without typing or receiving any new messages, which can expedite user operation.

The system may then analyze the received user input (operation 504). If the user input is a voice message, the system can apply a voice-recognition function to convert the message into text. The system may then determine, based on the user input, an enterprise objective of the user and a collaborative enterprise function associated with the user objective (operation 506). The enterprise objective may indicate an intention of the user to perform some work-related function or activity. For example, the enterprise objective can include an intention to inform a manager that the user needs to take a sick leave day, or an intention to manage a team project. The enterprise function may include information systems for collaborative enterprise work, e.g., time-off requests, collaboration on a shared document or presentation, video conferencing, distance learning, or task management.

In some embodiments, the system can analyze the user input locally within an EIM client executing on a mobile device to determine the enterprise function. Alternatively, the client device can transmit the input to a server which can analyze the user input. Then, the client device can determine the relevant enterprise function based on a context analysis result received from the server. In a further embodiment, when the user input contains a specific sequence of characters, the system can display a function selection window including a menu of enterprise functions. Then, the system can determine an enterprise function according to a selection by the user. The user can also define the specific sequence of characters corresponding to different enterprise functions, to improve the system's usability and efficiency.

The system then generates a user prompt corresponding to the enterprise function (operation 508). The system presents the user prompt for display in the application (e.g., EIM) window (operation 510). The system can use various triggers for displaying the user prompt corresponding to the enterprise function, which are not limited by the present disclosure. In addition, the system can first display a confirmation prompt associated with the user prompt in the application window, and when the user activates the confirmation prompt, the system can display a full user prompt or pop-up control.

The system can also pre-populate user option fields based on contents of the user input, as in the example shown in FIG. 2C. The system determines an enterprise function when one of the participants in an EIM session is set as an approving manager of the enterprise function. In addition, the system can show the user a menu of enterprise functions or of existing requests, and the user's choice can determine the user prompt that the system displays.

FIG. 5B presents a flowchart illustrating a method for generating context-appropriate user prompts based on a context analysis by a server, according to an embodiment. During operation, the system receives a user input in an application window (operation 552).

As shown in the example in FIG. 1, the EIM session window can contain a user input box, in which Xiaohei can input text, numbers, etc. In some embodiments, the system also provides other input methods, e.g. voice and multimedia input via a microphone and/or camera. For example, Xiaohei can input text via a device keyboard or soft-keyboard as shown in FIG. 1.

The system then determines whether to analyze the user input (operation 554). For example, the system can determine this based on a setting by the user, the availability of a network connection to a server, and/or the particular application or context. Responsive to determining that the user input should not be analyzed, the system can proceed to displaying the user input content within the application window (operation 566), without determining a relevant enterprise objective of the user.

In the case of analyzing the user input, the system can then upload the collected input content to a server (operation 556). In this embodiment, the EIM application client (e.g., a DingTalk client) can upload Xiaohei's input to a corresponding EIM server, and the server can determine whether the user input contains context relevant to an enterprise objective and enterprise function. The client system then receives the analysis results from the server (operation 558). The system can then determine whether a collaborative enterprise function is associated with the user input content (operation 560). If no such enterprise function exists (i.e., the system does not identify any enterprise function to be relevant to the user input content), the system then can proceed to displaying the user input content within the application window (operation 566).

Note that an EIM application such as DingTalk, besides supporting instant messaging, can also facilitate collaborative enterprise functions, such as request approval and attendance checking. Such efficient and effective interoperability between communication and collaborative teamwork functions, without the need for multiple applications, can be essential for organizations such as enterprises, government agencies, or nonprofits. In some embodiments, the EIM client (e.g., DingTalk) can analyze the input to determine context and upload the context to a server to determine a relevant enterprise function, if such a function exists. The server can use machine learning and language processing heuristics to analyze the input and determine the relevant enterprise objective and function.

Responsive to determining that there is a relevant enterprise function, the system can then generate a corresponding user prompt (operation 562). For example, if Xiaohei's input content matches the enterprise function of time-off requests, the system can display a confirmation prompt. When Xiaohei selects the confirmation prompt, the system displays a time-off request popup. In another embodiment, the system can display the time-off request popup directly without the confirmation step. The enterprise function popup can also be combined with the confirmation prompt, thereby allowing the user to configure the enterprise function within the original application window.

The system can then perform the enterprise function according to user input received via the generated user prompt (operation 564). Continuing the above example, if Xiaohei configures a time-off request, the system can then process this request. For instance, the system can send Xiaohei's request into the organization's information system or database for time-off requests, and/or send the request to Xiaohei's manager for approval.

Subsequently, the system processes the user text input content within the application (operation 566). For example, if the original application is an EIM session, the system can display the user input as an instant message, and accordingly send the message to the receiving party. In some embodiments, the processing in operation 566 can occur independently of the enterprise function, to avoid disruption to the messaging session between the two parties.

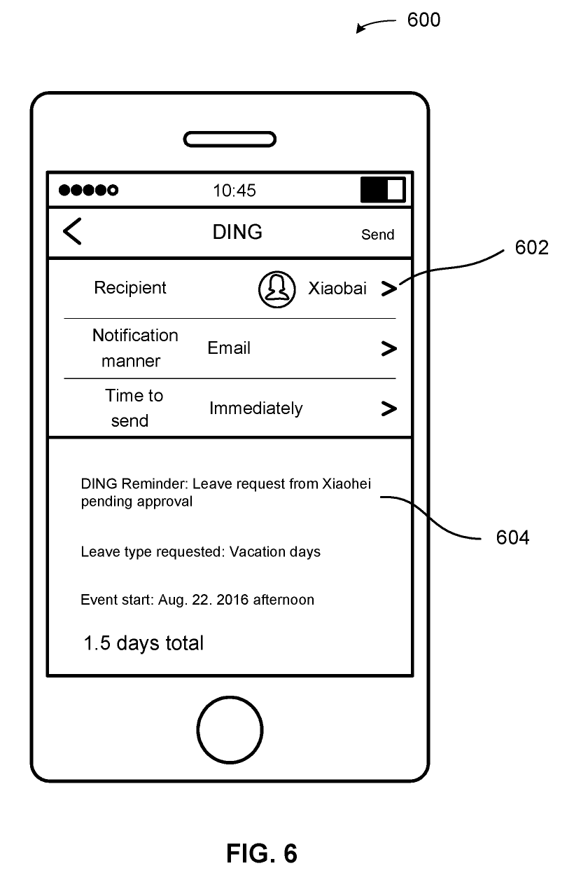

FIG. 6 illustrates generation of an exemplary user-targeting alert notification, according to an embodiment. As shown in FIG. 4C, the system can show Xiaohei a “reminder” or “DING message” control 466 in pending request list 460. When Xiaohei selects this control, the system generates a reminder about the pending request for Xiaohei's manager Xiaobai, based on options Xiaohei can choose in a configuration screen 600 as shown in FIG. 6. The system may extract context of the user input from the original application window, and may pre-populate configuration details of the reminder notification (or “DING message”) like the recipient field 602 of the notification, and its message content and request details 604. The system can then send a user-targeting alert notification to the recipient, as described above.

### Generating User Confirmation Prompts by a Client Device

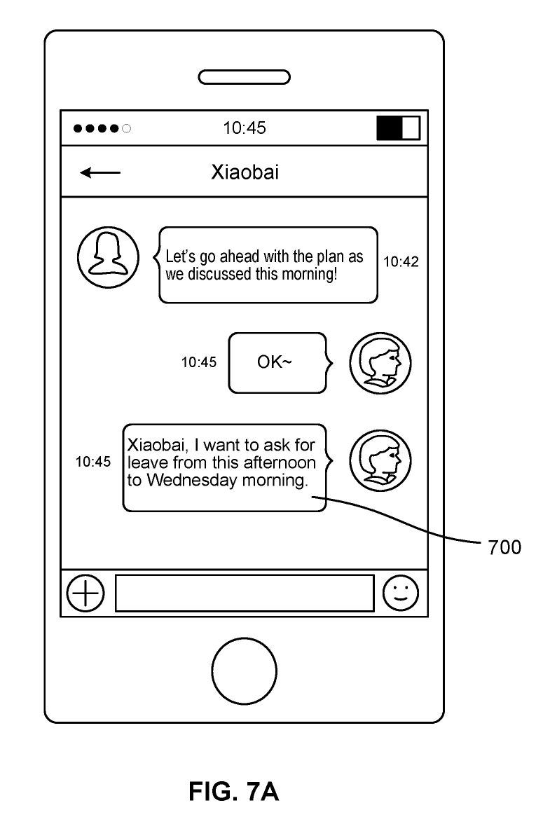

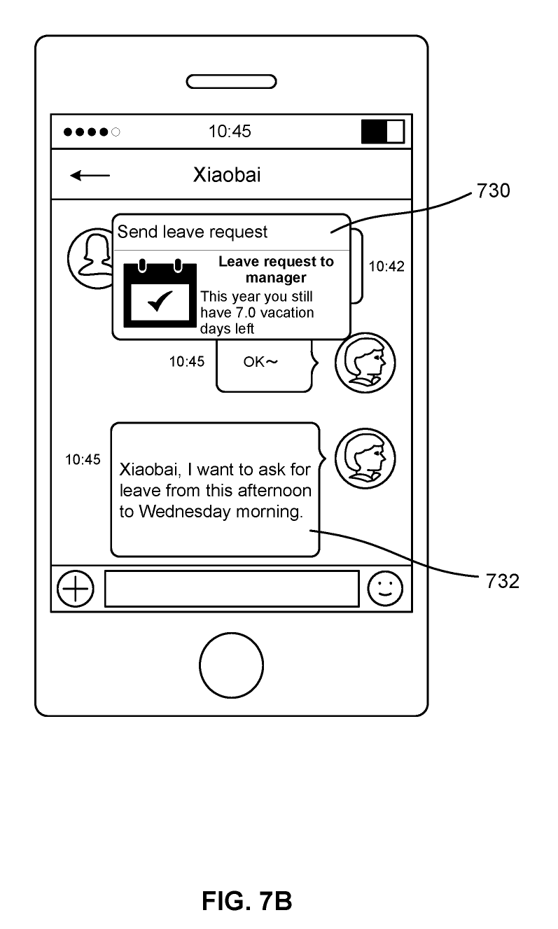

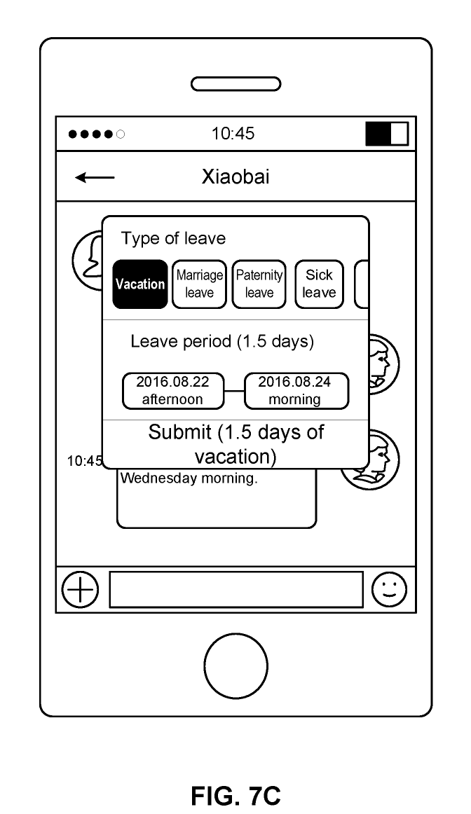

In an embodiment, the system can analyze the user input locally, i.e., without sending it to a server. FIG. 7A illustrates exemplary conversational context displayed on a mobile device client, according to an embodiment. In this embodiment, the system can use either sent (such as message 700) or received EIM messages together with unsent messages as the user input.

In some embodiments, the system uses a confirmation prompt to confirm that the user wishes to perform the enterprise function. FIG. 7B illustrates a context-appropriate user confirmation prompt 730 generated by a mobile device, according to an embodiment. In this example, user input 732 from Xiaohei is “Xiaobai, I want to ask for leave from this afternoon to Wednesday morning.” The EIM client then determines that input 732 corresponds to a time-off request, and can display a confirmation prompt 730, which indicates the available vacation days for user Xiaohei.

FIG. 7C illustrates pre-populated option field values in a context-appropriate form generated by a client, according to an embodiment. When Xiaohei selects “Send leave request” in the confirmation prompt shown in FIG. 7B, the system can display a context-appropriate form, as shown in FIG. 7C, with pre-populated values based on the user input.

### Analyzing Context Using Machine Learning

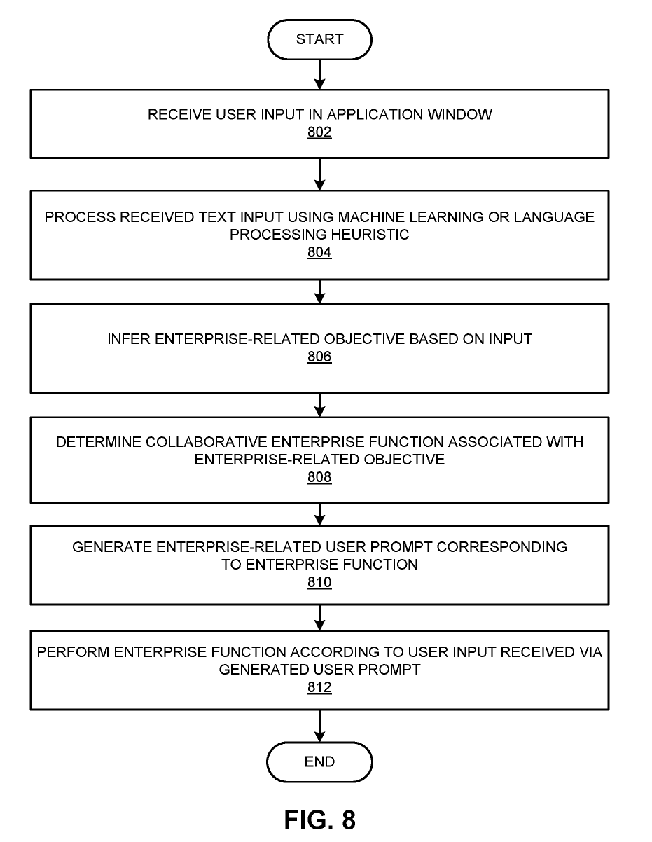

FIG. 8 presents a flowchart illustrating a method for analyzing context using machine learning, according to an embodiment. During operation, the system first receives a user input in an application window (operation 802).

The system then processes the received input using a machine learning or language processing heuristic (operation 804). In some embodiments, this heuristic may include supervised or unsupervised learning, clustering methods, a neural network, or another machine learning or language processing heuristic. The heuristic may be trained based on actual user interactions in an enterprise. In some embodiments, the system analyzes the user input locally on the device without needing to send the input content to a remote server.

The system then infers an enterprise-related objective based on the user input (operation 806). The system can determine a collaborative enterprise function associated with the enterprise-related objective (operation 808). Next, the system can generate an enterprise-related user prompt corresponding to the enterprise function (operation 810). The system then performs the enterprise function according to the user input received via the generated user prompt (operation 812). In some embodiments, users do not need to switch repeatedly between the EIM session window and application screens for each enterprise function, as both the EIM and enterprise functions can be performed in the EIM session window. This can increase the collaborative productivity of users.

Extracting Context from a User Search

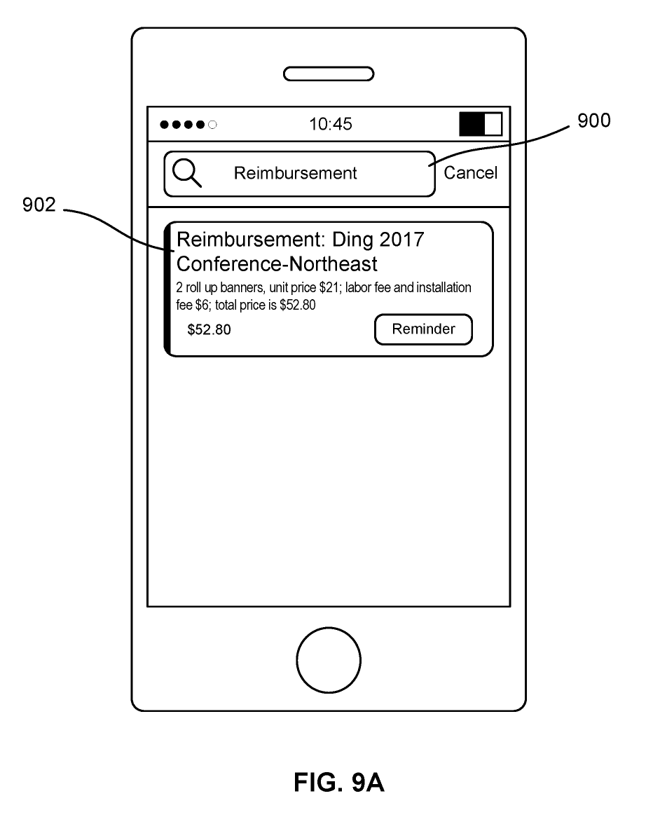

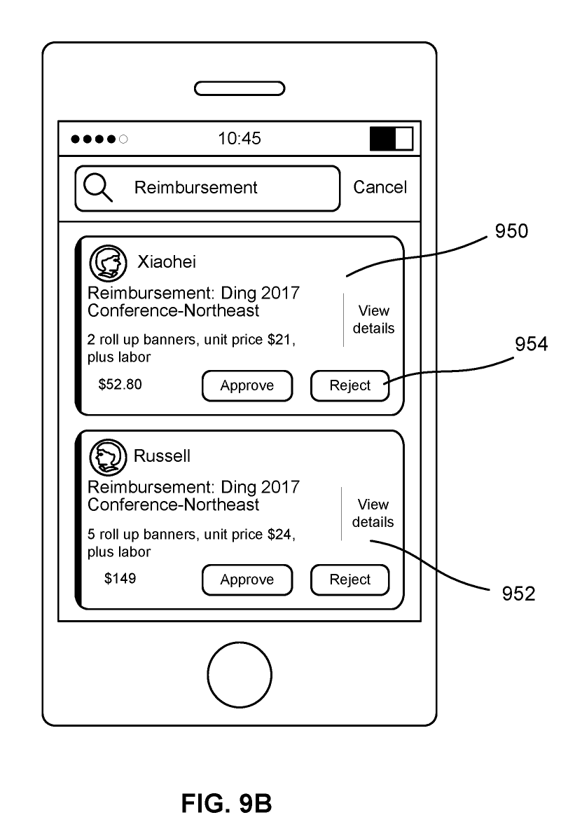

The disclosed embodiments are not limited to extracting context from user input in an EIM application window, but can include other user applications, such as search. The search could include an Internet, company intranet, or local device search. FIG. 9A illustrates an exemplary search resulting in a list of pending reimbursement requests, according to an embodiment. The list can include all requests related to a user and satisfying the user's search criteria. In this example, Xiaohei's input content 900 in a search page is “reimbursement,” thus the system can identify the enterprise function as “reimbursement request” and display the pending reimbursement request list. As shown in FIG. 9A, the displayed list includes a reimbursement request 902 initiated by Xiaohei. In some embodiments, the system may not restrict the list to requests involving Xiaohei, but instead may display all requests relevant to the determined context.

If the local user is a manager responsible for approving requests, the system can instead display a list including all pending requests received by the manager that are relevant to the determined context. FIG. 9B illustrates an exemplary search resulting in a list of all pending requests sent to a manager, according to an embodiment. In this example, Xiaobai's search input is “reimbursement,” so the system displays a list of pending reimbursement requests sent to Xiaobai. As shown, the list includes a request 950 to Xiaobai from Xiaohei, a request 952 to Xiaobai from the user Russell, etc.

In this example, the pending request list may contain additional controls. For example, when the local user Xiaobai is the approver, the system can display buttons 954 such as “Approve” and “Reject,” enabling Xiaobai to act on her approval decision efficiently. Moreover, if Xiaobai selects a “view details” button, the system may display a reimbursement request window showing full information of the selected request.

### User Configuration of a Request Type

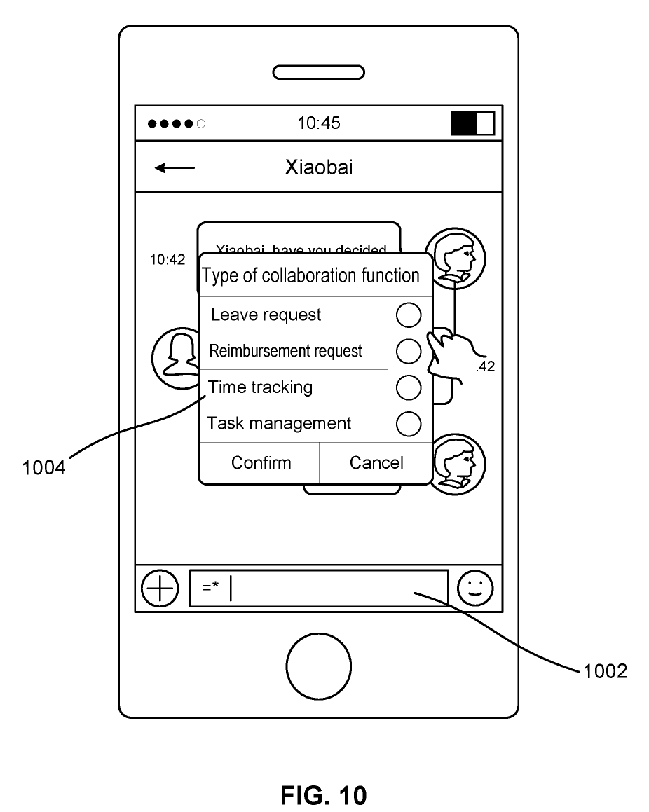

As discussed above, the user can configure the system to display a function selection window including a menu of enterprise functions when the user's input contains a specific sequence of characters. FIG. 10 illustrates user configuration of a request type, according to an embodiment. In this example, when the user enters the characters “=*” in an EIM session input field 1002, the system can display a menu of enterprise functions 1004, which can include leave request, reimbursement request, time or attendance tracking, and task management. The local user can then select an enterprise function, and the system can display a user prompt or window corresponding to the selected function.

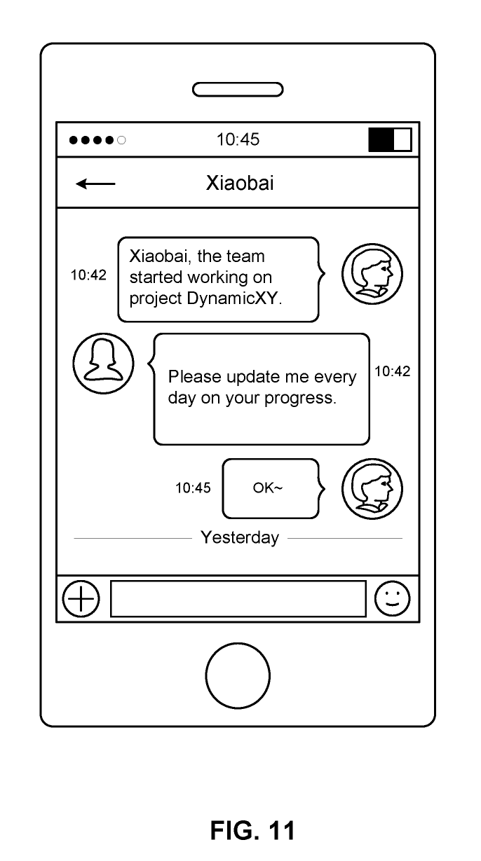

In addition to real-time user input as described above, the system can also extract context from historical input in the application window (e.g., an EIM session window, search window, etc.). FIG. 11 illustrates exemplary historical user input being used by the system to facilitate task management, according to an embodiment. In this example, when Xiaohei opens an EIM session window, the system loads a historical conversation, including a message received on the previous day from Xiaobai asking Xiaohei to update her every day on a project's progress. The system can then determine that Xiaohei is likely to send a task management log to Xiaobai every day. Correspondingly, the system can bring up a prompt to facilitate the task management.

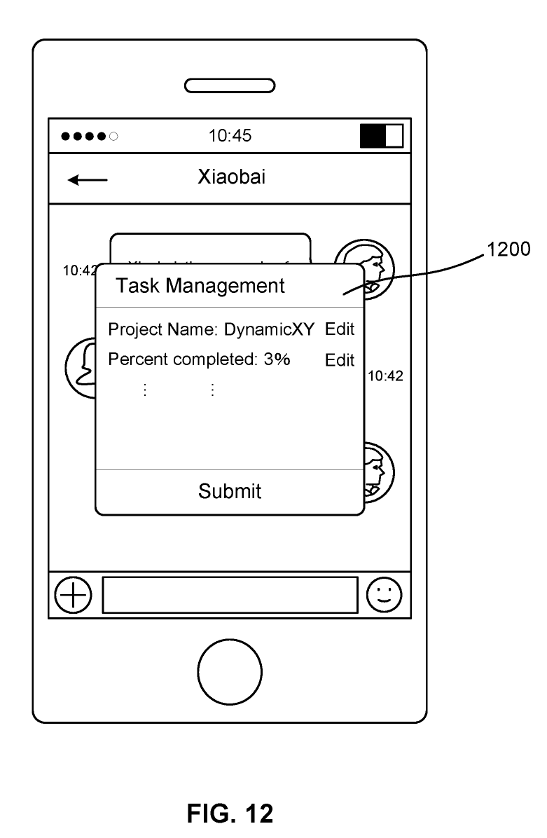

FIG. 12 illustrates a context-appropriate user prompt to perform a task management function, according to an embodiment. Here, in conjunction with the example in FIG. 11, the system can display a task management prompt 1200. Xiaohei can then efficiently submit a daily project update. In some embodiments, the system can first display a confirmation prompt, such that when Xiaohei confirms the prompt, the system displays the task management window. Note that, in some embodiments, once the system has initially analyzed the user input context, it can keep track of Xiaohei's reporting requirement, and therefore trigger the task management function daily even without re-loading the user input.

### Exemplary Embodiments

The embodiments described herein provide a system and method generating context-appropriate user prompts from an application. During operation, the system receives a user input in the application window. The system then analyzes the received user input to determine an enterprise function corresponding to the user input. The system then generates a user prompt corresponding to the enterprise function. The system then displays the user prompt in the application window.

In a variation on this embodiment, analyzing the user input to determine the enterprise function comprises applying a language processing heuristic to the input.

In a variation on this embodiment, the received user text input includes a chat message or search term.

In a variation on this embodiment, the generated user prompt includes an enterprise-related form, which further includes a user option field. Generating the user prompt further comprises pre-populating the user option field.

In a variation on this embodiment, the enterprise function includes one or more of: a reimbursement or expense request; a vacation or leave request; and task management information.

In a variation on this embodiment, the system further generates a list of pending requests involving the user and relating to the enterprise function. The system then displays the list of pending requests in the application window.

In a variation on this embodiment, the enterprise application is an instant messaging application.

### Exemplary Computer System

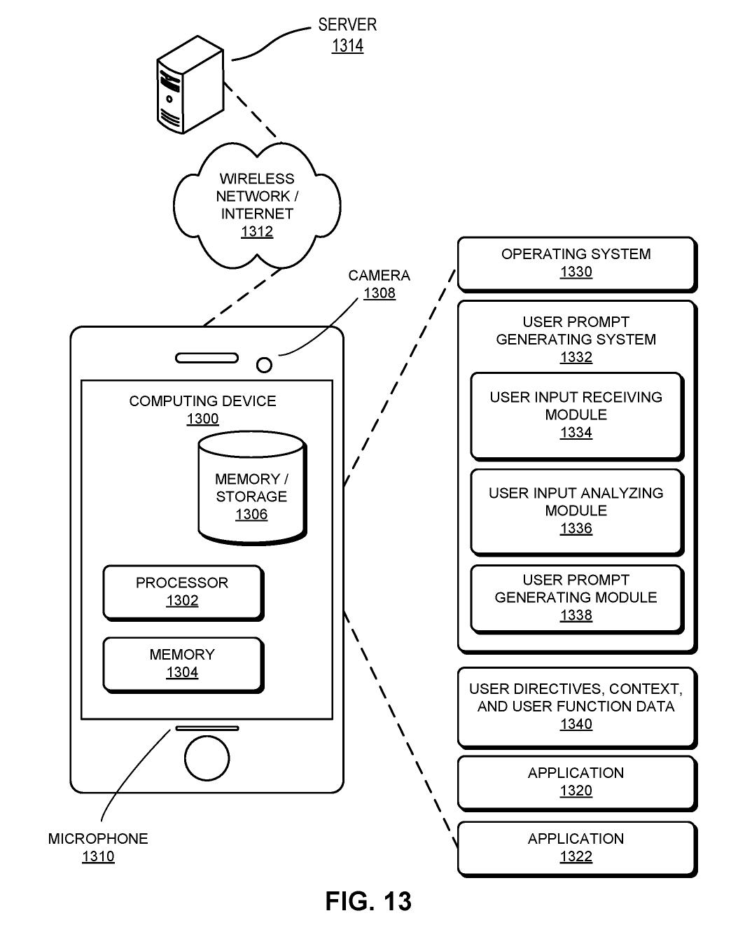

FIG. 13 presents a block diagram illustrating an exemplary computer system for generating context-appropriate user prompts, according to an embodiment. In this example, a computing device 1300, which may be a mobile device, includes one or more processors 1302, a memory 1304, and a storage device or solid-state non-volatile memory 1306. Storage device 1306 typically stores instructions that can be loaded into memory 1304 and executed by processor 1302 to perform the methods mentioned above. As a result, device 1300 can perform the functions described above. Computing device 1300 can also include camera 1308 and microphone 1310, which can be used to record voice and/or multimedia messages, according to embodiments of the present invention. Computing device 1300 may also be coupled via one or more network interfaces to one or more networks. Specifically, device 1300 may be connected to local network, wireless network, or internet 1312, and may communicate with server 1314 via such a network. In some embodiments, server 1314 can perform some functions of the present invention, for example analyzing the received user input to determine an enterprise objective of a user and an enterprise function associated with the user objective.

In one embodiment, processor 1302 can execute instructions in storage device 1306 in order to implement operating system 1330 and user prompt generating system 1332, which can comprise various modules. In one embodiment, instructions in storage device 1306 can implement a user input receiving module 1334, a user input analyzing module 1336, and a user prompt generating module 1338.

User input receiving module 1334 can receive user input in an application window. User input analyzing module 1336 may analyze the user input to determine an enterprise objective of a user and an enterprise function. User prompt generating module 1338 may generate a user prompt corresponding to the enterprise function.

In some embodiments, modules 1334, 1336, and 1338 can be partially or entirely implemented in hardware and can be part of processor 1302. Further, in some embodiments, the system may not include a separate processor and memory. Instead, in addition to performing their specific tasks, modules 1334, 1336, and 1338, either separately or in concert, may be part of general- or special-purpose computation engines.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executed method for generating context-appropriate user prompts from an application, comprising:
receiving, by a computing device executing the application, a user input in the application;
analyzing the received user input to determine an enterprise function corresponding to the user input;
generating a user prompt corresponding to the enterprise function; and
displaying the user prompt in the application window.

2. The method of claim 1, wherein analyzing the user input to determine the enterprise function comprises applying a language processing heuristic to the input.

3. The method of claim 1, wherein the received user input includes a chat message or search term.

4. The method of claim 1:
wherein the generated user prompt includes an enterprise-related form, which further includes a user option field; and
wherein generating the user prompt further comprises pre-populating the user option field.

5. The method of claim 1, wherein the enterprise function includes one or more of:
a reimbursement or expense request;
a vacation or leave request; and
task management information.

6. The method of claim 1, further comprising:
generating a list of pending requests involving the user and relating to the enterprise function; and
displaying the list of pending requests in the application window.

7. The method of claim 1, wherein the application is an instant messaging application.

8. A computing server system for generating context-appropriate user prompts for an application, the server system comprising:
a set of processors; and
a non-transitory computer-readable medium coupled to the set of processors storing instructions thereon that, when executed by the processors, cause the processors to perform a method for generating context-appropriate user prompts, the method comprising:
receiving, from a client device, a user input in the application window;
analyzing the received user input to determine an enterprise function corresponding to the user input;
generating a user prompt corresponding to the enterprise function; and
sending the user prompt to the client device for display in the application window.

9. The computing server system of claim 8, wherein analyzing the user input to determine the enterprise function comprises applying a language processing heuristic to the input.

10. The computing server system of claim 8, wherein the received user input includes a chat message or search term.

11. The computing server system of claim 8:
wherein the generated user prompt includes an enterprise-related form, which further includes a user option field; and
wherein generating the user prompt further comprises pre-populating the user option field.

12. The computing server system of claim 8, wherein the enterprise function includes one or more of:
a reimbursement or expense request;
a vacation or leave request; and
task management information.

13. The computing server system of claim 8, wherein the method further comprises:
generating a list of pending requests involving the user and relating to the enterprise function; and
sending the list of pending requests to the client device for display in the application window.

14. The computing server system of claim 8, wherein the application is an instant messaging application.

15. A non-transitory computer-readable storage medium storing instructions that, when executed by a computing device, cause the computing device to perform a method for generating context-appropriate user prompts from an application, the method comprising:
receiving a user input in the application window;
analyzing the received user input to determine an enterprise function associated with the user objective;
generating a user prompt corresponding to the enterprise function; and
presenting the user prompt for display in the application window.

16. The non-transitory computer-readable storage medium of claim 15, wherein analyzing the user input to determine the enterprise function comprises applying a language processing heuristic to the input.

17. The non-transitory computer-readable storage medium of claim 15, wherein the received user input includes a chat message or search term.

18. The non-transitory computer-readable storage medium of claim 15:
wherein the generated user prompt includes an enterprise-related form, which further includes a user option field; and
wherein generating the user prompt further comprises pre-populating the user option field.

19. The non-transitory computer-readable storage medium of claim 15, wherein the enterprise function includes one or more of:
a reimbursement or expense request;
a vacation or leave request; and
task management information.

20. The non-transitory computer-readable storage medium of claim 15, wherein the method further comprises:
generating a list of pending requests involving the user and relating to the enterprise function; and
displaying the list of pending requests in the application window.
